(19) United States
(12) Patent Application Publication
(10) Pub. No.: US 2008/0121185 A1
(43) Pub. Date: May 29, 2008

(54) System and method of production for milk products

(76) Inventor: Talo Tamminga, Cambridge (CA)

Correspondence Address: HOWREY LLP, C/O IP DOCKETING DEPARTMENT, 2941 FAIRVIEW PARK DR., SUITE 200, FALLS CHURCH, VA, 22042, US

(21) Appl. No.: 11/604,369

(22) Filed: Nov. 27, 2006

(51) Int. Cl. A01J 5/00; A23C 3/00; B65B 55/00

(52) U.S. Cl. 119/14.02; 119/14.08; 426/383; 426/392; 426/580; 436/20

(57) ABSTRACT

A system and method for producing milk is disclosed in which animals present themselves for milking on a voluntary basis. The milk produced is handled and processed separately from milk and dairy products produced by conventional milking. Advantageous characteristics of the milk are retained and can be made available for the consumer. The production process may also be adapted to the voluntary milking facilities.

### BACKGROUND OF THE INVENTION

1. Field of the Invention

The invention relates generally to milk production and processing methods and more particularly to methods of producing milk products that are sympathetic to the needs of the dairy animal. The invention further relates to a system for processing milk and an improved milk product produced according to such methods.

2. Description of the Related Art

It is well known to produce milk by milking cows or other dairy animals using milking machines. Today, relatively little milk is produced by hand and this is of an insignificant commercial value and will not be discussed further. Most milking herds are milked twice or three times a day. This may take place in a dedicated milking parlour whereby the cows are led or driven to the milking parlour for milking and then released. The cows may be kept indoors in cowsheds or may be kept outdoors and brought to the parlour at milking time. This may vary from country to country and also according to the time of year. In intensive farming situations, the cows may be kept indoors for most of their lives and will be milked according to a demanding schedule that exhausts an animal within two or three years, after which it is slaughtered.

An alternative form of milking arrangement is the tie stall with pipeline. In such a system, the cows may be tethered and milked at their feeding station. Pipelines extend throughout the cowshed to provide milking vacuum to and transport milk from each milking device. The cows are then milked according to the particular milking scheme implemented by the farmer or dairy person. In certain tie stall cowsheds, the animals may be let out periodically to pasture. Increasingly, in intensive farming practices, the animals are kept tied for a considerable part of their lives. Such practices are generally far from ideal for animal welfare.

More recently, robotic milking machines have been developed. These milking robots are significant since they allow the teat cups of the milking machine to be connected to the teats of the cow or other dairy animal automatically. The whole milking procedure may thus be carried out without intervention of a human operator. Although the mechanization of farming procedures may be seen by some as inhumane, the use of a robot allows greater care and freedom to be given to the animal for the following reasons.

Firstly, use of a robot allows the animal to choose when it wishes to be milked. Since a human operator is absent, there is no longer a need to adhere to a specific time table. Each cow may individually decide how frequently she wishes to be milked. For some cows this will be twice a day, for other cows three times. Voluntary milking has been shown to improve the yield of an animal and significantly avoids problems due e.g. to over distended udders.

Secondly, by allowing the cows to report for milking on a voluntary basis, the milking machine may be used more effectively. A single milking robot may serve to milk a herd of around 60 animals. The robot may therefore include further refinements and procedures that would perhaps be too expensive were they to be replicated in a multiple stall milking parlour. Furthermore, since a human operator is not present, monitoring of the animals health and the milk quality must be performed by the robot. Since robots are presently better suited for monitoring all possible faults at an early stage, the resulting standard of care is significantly improved and extremely low levels of bacteria and somatic cells are frequent in milk produced using today's robots.

Robot systems that are available at present include the Astronaut™ milking system available from Lely International and the VMS™ milking system available from DeLaval. Although robotic milking machines presently exist, the milk produced has generally been collected and processed together with milk from other sources. Any advantageous characteristics of this milk are therefore diluted and cannot be taken advantage of during the processing of the milk. These qualities can thus also not be appreciated by the consumer. In this context, it is believed that milk produced from robotic or voluntary milking machines has a different composition from milk produced by non-voluntary machines. In particular, the ability of the cows to present themselves voluntarily for milking can lead to reduced levels of stress hormones in the milk. Although in certain cases, voluntary or robotically produced dairy products may have been produced on site at individual farms, it is believed that the problems of collecting from a plurality of milking facilities and maintaining such milk separate from milk from other sources has not been addressed.

Additionally, since current processing facilities deal with milk from distinct sources having varying characteristics, the milk processing facility must be adapted to meet the lowest common criteria for milk supplied to it. Robotic milking machines are well adapted to testing, grading and separating the milk and can perform certain processing steps that would otherwise be performed at the dairy processing facility. In the past, since robotically produced milk was mixed with other milk, any benefits would be lost and the processing facility would thus not operate in the most efficient manner.

### BRIEF SUMMARY OF THE INVENTION

The present invention addresses these problems by providing an improved method of producing milk. The method comprises providing a plurality of voluntary milking machines, allowing dairy animals free access to visit the milking machines for the purpose of milking, milking the dairy animals, collecting the milk from the milking machines, processing the collected milk to form a processed milk product derived exclusively from the voluntary milking machines and packaging the processed milk product. The packaged milk product may then be subsequently transported and marketed as required. By separately and exclusively processing this voluntarily produced milk, it is possible to take advantage of its improved characteristics. Such characteristics may include reduced levels of stress hormones in the milk, improved fat protein or vitamin content and lower levels of impurities and microbial contamination. This may have beneficial consequences for both the consumer and for the processing facility. Furthermore, consumers are increasingly conscious of ethical and environmental aspects related to farming. Providing and guaranteeing that dairy products have been produced according to accepted criteria has an added advantage in the marketing of such products. In this manner, individual consumers have the opportunity to influence the manner in which animals are treated according to their purchase patterns.

According to an important aspect of the invention, the voluntary milking machines are milking robots that automatically perform the milking of the dairy animals. In this manner, greater efficiency of the complete milk processing chain may be achieved and human intervention is minimised.

According to a further aspect of the invention, the milk is tested according to a criterion related to the voluntary production of milk and only the milk that satisfies the criterion is processed. Additionally or alternatively the milking machines may be present in one or more milking facilities and the milking facility is tested according to a criterion related to the voluntary production of milk and only milk from facilities that satisfy the criterion is processed. In this manner it may be ensured that adequately stringent procedures are in place to ensure that the milk indeed originates from voluntary milking facilities. A number of different criteria may be included in the testing procedure. The milk may thus be tested against animal welfare criteria, e.g. by measuring constituents in the milk that reflect the condition of the animal such as stress hormones or fat content. The milking facility may also be tested against animal welfare criteria e.g. regular inspections may be carried out to ensure that the cows are kept according to established guidelines for voluntary milking facilities. There may be different levels of criteria, covering e.g. organic production, free range production, loose stall production each requiring that different conditions be maintained.

Additionally or alternatively, the criteria for testing the milk or the milking facility may include milk quality criteria or public health criteria. The use of consistent modern robotic milking devices offers the possibility of including elevated milk quality control at the point of milking. Since all of the processed milk originates from such robots, greater harmonization of quality may be achieved allowing also a greater attention to factors affecting public health including, but not limited to: levels of noxious substances such as pesticides, dioxins and heavy metals; hormone content; fat content; and vitamin content. The complete process including the milking, transport, processing, packaging and distribution facilities may also be tested according to environmental criteria. Stringent environmental criteria may be defined e.g. by the coordinating organization responsible for the process. These may include criteria relating to farming and husbandry such as the care for the land and the use of environmentally acceptable products and feeds. They may also relate to the modes of transport and the fuels used and the energy efficiency and design of the processing facility. In relation to the packaging and marketing of the dairy produce, environmental criteria may dictate the nature of the packaging used, requiring it to be recyclable or reusable.

According to a yet further aspect of the present invention, the milking machines may be present in one or more milking facilities and the processing may take place at least partially at the milking facility. As mentioned above, as a consequence of the fact that all of the animals are milked using at least partially standardized, voluntary milking devices, certain processing steps may already take place at the milking facility. This may lead to advantageous improvements in the overall efficiency of the process and may also lead to higher quality products and less wastage. It is also possible for the complete processing of the milk to take place at the milking facility. In this case the packaging may also takes place at the milking facility. Particularly in this case, the packaging may give an indication of the origin of the milk and also of the fact that it is voluntarily produced according to the criterion disclosed herein. It may in such cases be possible to even indicate on the package the individual animal or animals from which the milk has been derived.

According to a further aspect of the present invention, there is also provided a system for processing milk comprising a plurality of voluntary milking machines to which dairy animals may have free access for the purpose of milking, a milk collecting facility operatively arranged for collecting the milk from the milking machines, a milk processing facility operatively arranged for receiving the collected milk for exclusively processing the milk collected from the voluntary milking machines to form processed milk and a packaging facility operatively arranged to receive and package the processed milk. Such a system may provide the benefits of the method as described above.

According to one aspect of the system according to the invention, the milk collecting facility may comprise a transportable milk tank connectable to receive milk from the milking machines and deliver milk to the milk processing facility. Such a bulk milk tanker could be substantially conventional and dedicated to the transport of voluntarily produced milk. Alternative systems using milk cans and the like may also be considered.

According to a yet further aspect of the invention, the system may further comprise a testing facility for testing the milking machines, the milk processing facility, the milk collecting facility or the packaging facility according to a criterion related to the voluntary production of milk. The testing facility may comprise automated or computerized testing procedures. Additionally or alternatively it may comprise human testers that investigate and record the criteria.

The invention further relates to a method of producing processed milk products from milk collected from dairy animals in a voluntary milking facility in which dairy animals are allowed voluntary access to visit milking machines for the purpose of milking, the method comprising collecting milk exclusively from voluntary milking facilities; processing the collected milk to form processed milk derived exclusively from the voluntary milking facilities; and packaging the processed milk product. Such a method may benefit from the advantages as outlined above in that the milk may be handled in a more efficient process. As described above, the milking machines are preferably milking robots that automatically perform the milking of the dairy animals and the milk and the whole production process may be subjected to stringent testing according to appropriate criteria.

The invention also relates to a processed and packaged milk product comprising processed milk derived exclusively from the milk of dairy animals in a voluntary milking facility, in which the dairy animals are allowed voluntary access to visit milking machines for the purpose of milking. In this sense, such a product is understood to be new in that it is distinct in terms of composition due to the fact that the cow has voluntarily given milk in a manner that reduces stress levels in the milk. Furthermore, the criteria used to test the milk and its production process will also influence the composition of the final dairy product. The milk product may be packaged to include an indication of the manner in which it has been produced and of certain criterion employed in its testing. Preferably, the package also includes an indication of the particular milking facility or herd from whence the milk has been collected. In an automated procedure it may also be desirable to include an indication of the animal that has produced the milk.

### BRIEF DESCRIPTION OF THE DRAWINGS

The features and advantages of the invention will be appreciated upon reference to the following drawings, in which:

FIG. 1 is a plan view of an embodiment of the invention showing the various facilities involved in the production of a dairy product.

### DESCRIPTION OF ILLUSTRATIVE EMBODIMENTS

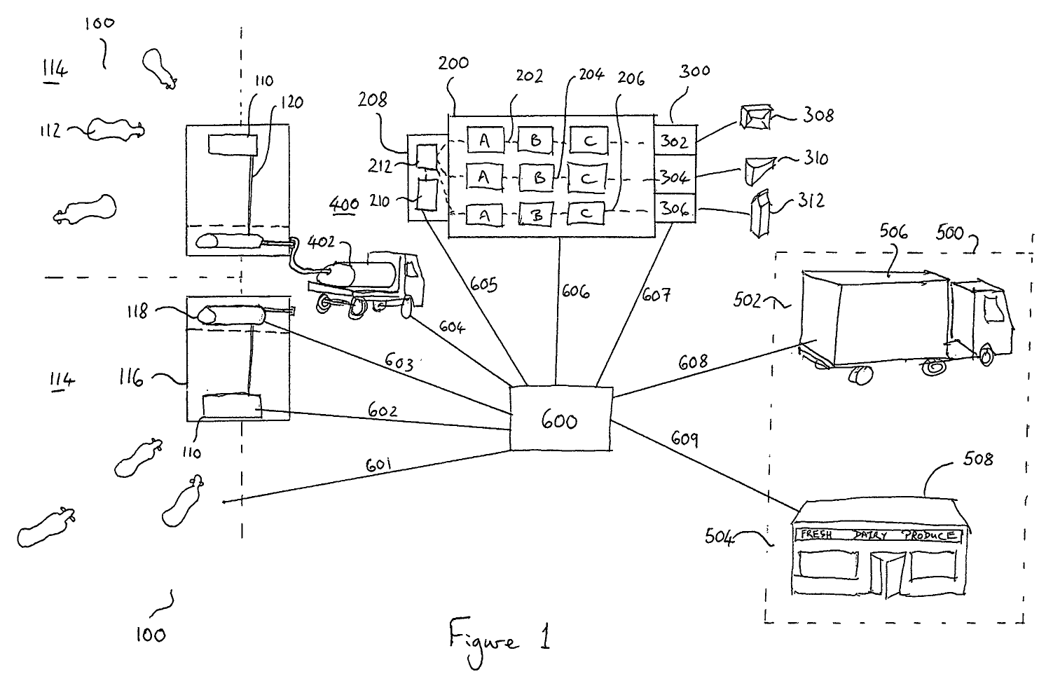

The following is a description of certain embodiments of the invention, given by way of example only and with reference to the drawing. Referring to FIG. 1, a milk processing system 1 according to a first aspect of the invention is shown comprising a plurality of milking facilities 100 each of which has a milking robot 110. For the present purpose, each milking facility 100 may be considered to be an independently operating farm. While one milking robot 110 has been shown per milking facility 100, it is also possible that a milking facility has a plurality of milking robots 110, depending on the size of the herd. Milking robots 110 are of the Astronaut A3™ type, available from Lely International Inc and will not be further described at present. It is nevertheless understood that alternative voluntary milking facilities may also be used, subject to the criteria defined below. A characteristic of the milking robots 110 is that they allow voluntary milking as and when an individual animal demands. Cows 112 are free to graze in the pastures 114 of the milking facilities 100 and are also able to take shelter in cowsheds 116 at night or during inclement weather. For convenience and environmental protection, the milking robots 110 are also located in cowsheds 116. It is however understood that the robots 110 may also be located externally in the pastures 114 in order to provide more immediate access for the cows 112 during grazing. Also located in cowsheds 116 are milk tanks 118 for collecting, storing and cooling milk. The milk tanks 118 are connected to the milking robots 110 by milk lines 120.

Located at a distance from the milking facility 100 is a processing facility 200. Processing facility 200 is a dairy produce processing facility having an upstream section 208 for receipt of milk from the milking facility. The upstream section 208 comprises test unit 210 and separator unit 212 in which the milk is separated into its components e.g. by centrifugation. The processing facility 200 also has process lines 202, 204, 206 for producing different dairy products including e.g. butter, cheese and milk. The butter line 202 comprises process sections 202A, 202B and 202C comprising processes necessary for the processing of butter. The process sections 202A, 202B and 202C may comprise standard processes common in the art of butter making and will not be defined in further detail in the present application. Similarly, cheese process line 204 comprises process sections 204A, 204B and 204C comprising processes necessary for the processing of cheese. Milk process line 206 also has process sections including a reconstitution section 206A, a homogenization section 206B and a pasteurizing section 206C. These processes may be generally conventional and will not be described in further detail in the present application. Processing facility 200 is dedicated to the processing of products originating from milk produced by milking robots 110. It will be understood that further products may be processed at the processing facility 200 e.g. in a separate section for non-voluntary milk products. It will also be understood that products such as the processed milk produced by the processing facility 200 may be further processed elsewhere into further refined products such as ice cream or bakery products. The further processing may also of course be carried out exclusively according to the invention, in which case it would be subject to the same testing criteria as defined below and could be packaged and marketed accordingly.

At a downstream side of the processing facility there is provided a packaging facility 300 having packaging lines 302, 304, 306 for the packaging of the produce of the process lines 202, 204, 206 as packaged products 308, 310, 312. Although the packaging facility is referred to as a separate facility, it is understood that sections of the facility may be spatially separated at different locations according to the location of the particular process line.

FIG. 1 also indicates a milk collecting or transporting facility 400. According to the presently described embodiment, milk transporting facility 400 comprises a bulk tanker 402, adapted to receive milk from the milk tanks 118 and transport it to the upstream section 208 of the processing facility 200. Nevertheless, it is also envisaged that alternative milk transporting systems could be employed which would be equivalent to the bulk tanker depicted e.g. based on the use of milk cans.

There is also illustrated a marketing facility 500. Marketing facility 500 comprises a distribution system 502 and a sales system 504. The distribution system 502 comprises refrigerated transport in the form of truck 506 and may also include other elements common to known distribution systems, including other forms of transport, warehouses and related logistics and support. Sales system 504 comprises shops 508 but may also include other elements common to existing sales systems, including on-line shops, farm outlets, restaurants and other service facilities and also advertising and the like. Unlike the other facilities hitherto described, marketing facility 500 need not be dedicated exclusively to milk and dairy products derived from milking robots 110 according to the voluntary milking principle. Other dairy produce originating from other sources may thus also be distributed and sold subject to the criteria discussed below.

The milk processing system 1 of the present invention also comprises a testing facility 600. Testing facility 600 is arranged to interact with some or all of the facilities described above as indicated by lines 601-610 in order to test aspects of the milk processing system 1 according to predetermined criteria. As an example of the criteria that may be tested, line 601 indicates testing of the pastures 114 according to environmental criteria. Line 602 indicates testing at the milk robot 110 according to milk quality criteria. Line 603 indicates the testing of the bulk tank 118 according to a time criterion. Line 604 indicates testing of the collection facility according to an identity criterion to determine whether milk received actually comes from an accepted milking facility. Line 605 indicates testing at the test unit 210 according to milk constitution criteria. Line 606 indicates testing of the processing facility 200 according to quality criteria. Line 607 indicates testing of the packaging facility according to environmental criteria. Line 608 indicates testing of the distribution system 502 according to further environmental criteria. Line 609 indicates testing of sales system 504 according to ethical criteria. The skilled person will be well aware that the criteria indicated above in relation to one process may also apply to another process and that many further criteria may also be taken into account in order to ensure that the system operates as required and meets all standards.

In use, the system 1 works as follows. The cows 112 graze in the pastures 114 and are able to report voluntarily to a milking robot 110 at any point in time when they desire to be milked. Arrival of a cow 112 at the milking robot 110 is detected by appropriate recognition devices (not shown) and the milking procedure may commence. The milking procedure may comprise a number of steps including grooming, washing, pre-milking, milking, post milking, disinfecting, feeding and any other procedures that it may be appropriate to perform on the animal in question. Although generally speaking a cow 112 may report to be milked at any moment that she desires, there may nevertheless be placed limits on the number of times she may present herself within a given period. These measures are well known to the skilled practitioner in the field of milking robots and will not be further dealt with here. The milk is collected by the milking robot 110 and is passed via the milk line 120 to milk tank 118 where it is immediately cooled. Within a given maximum period of time, or after a maximum amount of milk has been produced, the milk is collected by bulk tanker 402. Unlike in previous systems, bulk tanker 402 is dedicated to receiving milk from milking facilities 100 according to accepted criteria, in particular, that milking has taken place in a voluntary manner. The milk carried by the bulk tanker 402 is thus not mixed with milk from other sources. It is thus understood that other milking facilities (not shown) may be present that do not meet the voluntary milking criteria. The bulk tanker 402 makes a selection between those milking facilities 100 that meet the criteria and those which do not, and collects milk only from those milking facilities 100 that meet the criteria.

The bulk tanker 402 delivers the milk to the upstream section 208 of the processing facility 200, where it is again tested at line 605 according to whether it has been produced by an accepted milking facility. If the milk meets the criteria, it will be processed in one of lines 202, 204, 206 to an appropriate dairy product. The product is subsequently packaged by packaging facility 300. Of significance, the packaging denotes the provenance of the dairy product 308, 310, 312. It may also list some or all of the criteria that the product has been tested for. Milk that does not meet the criteria may be discarded or, if otherwise fit for consumption may be processed in a separate line (not shown) and packaged as a distinct product. Thereafter, the packaged products 308, 310, 312 are distributed via distribution system 502 and sold via sales system 504. During sales and distribution, the packaged products 308, 310, 312 will still be identified by their packaging and by other indicators as having come from the milking facility 100 according to the defined criteria. This is clearly beneficial for quality control purposes. Although not presently depicted, it is understood that with appropriate transport and processing facilities it may also be possible to provide an indication of the individual animal that has produced the milk.

As an indication of criteria that could be applied to the milk processing system 1 of the present invention, the following example is given:

### EXAMPLE

A milk processing scheme is proposed in which the following criteria are required by all farms contributing to the scheme and by all parties in the subsequent processing of the milk and dairy products.

1. Farmers are required to comply with the following criteria regarding ethical treatment of the animals:

a. They will not be hit by foreign objects;

b. They will have comfort stalls of at least 105 cm wide;

c. There will be stalls for at least 90% of the herd;

d. They will have outside access on demand (subject to health risk);

e. Medicines will be administered as prescribed by a veterinary practitioner;

f. In cases of (fatal) distress proper euthanasia will be applied on the farm.

2. The farm must comply with the following criteria regarding food safety.

a. Comfort stalls will be cleaned at least 2 times a day

b. Robot room will be cleaned at least 2 times a day

c. There will be no BST hormone use in the herd;

d. The farm and milk will otherwise comply with the local guidelines for organic milk production.

3. The farm must comply with the following environmental criteria:

a. Liquid milk will be supplied from local farms (within a 250 km range)

b. Milking herd size will have a maximum limit of 200 cows;

c. The milk will be packaged in either biodegradable packages or glass bottles.

4. The farm must comply with the following social criteria:

a. the scheme shall guarantee the dairy farmer an environment for profitable and sustainable operation;

b. the dairy worker will not work more than 48 hours weekly and will receive no less than 120% of the national minimum wage.

Thus, the invention has been described by reference to the embodiment discussed above. It will be recognized that this embodiment is merely exemplary and is not limiting upon the scope of the invention. Many modifications in addition to those described above may be made to the structures and techniques described herein without departing from the spirit and scope of the invention.

What is claimed is:

1. A method of producing milk products, comprising:
providing a plurality of voluntary milking machines located at different milking facilities;
allowing dairy animals free access to visit the milking machines for the purpose of milking;
milking the dairy animals;
transporting the milk from the milking facilities to a processing facility;
processing the collected milk to form a processed milk product derived exclusively from the voluntary milking machines; and
packaging the processed milk product.

2. The method of claim 1, wherein the voluntary milking machines are milking robots that automatically perform the milking of the dairy animals.

3. The method of claim 1, wherein the milk is tested according to a criterion related to the voluntary production of milk and only the milk that satisfies the criterion is processed.

4. The method of claim 3, wherein the criterion is an animal welfare criterion.

5. The method of claim 3, wherein the criterion is a milk quality criterion.

6. The method of claim 1, wherein the milking facility is tested according to a criterion related to the voluntary production of milk and only milk from facilities that satisfy the criterion is processed.

7. The method of claim 6, wherein the criterion is an animal welfare criterion.

8. The method of claim 6, wherein the criterion is a public health criterion.

9. The method of claim 6, wherein the criterion is an environmental criterion.

10. The method of claim 1, wherein the processing takes place at least partially at the milking facility.

11. The method of claim 1, wherein the packaged product is marked with an indication that the milk is produced according to a voluntary milking criterion.

12. A system for processing milk comprising:
a plurality of voluntary milking machines to which dairy animals may have free access for the purpose of milking;
a milk transporting facility operatively arranged for collecting the milk from the milking machines;
a milk processing facility operatively arranged for receiving the collected milk for exclusively processing the milk collected from the voluntary milking machines to form a processed milk product; and
a packaging facility operatively arranged to receive and package the processed milk product.

13. The system of claim 12, further comprising a marketing facility arranged for exclusively marketing the packaged product.

14. The system of claim 12, wherein the milk transporting facility comprises a transportable milk tank connectable to receive milk from the milking machines and deliver milk to the milk processing facility.

15. The system of claim 12, further comprising a testing facility for testing the milking machines, the milk processing facility, the milk transporting facility or the packaging facility according to a criterion related to the voluntary production of milk.

16. A method of producing milk products from milk collected from dairy animals in voluntary milking facilities in which dairy animals are allowed voluntary access to visit milking machines for the purpose of milking, the method comprising
collecting milk exclusively from the voluntary milking facilities;
processing the collected milk to form a processed milk product derived exclusively from the voluntary milking facilities; and
packaging the processed milk in a package.

17. The method of claim 16, wherein the milking machines are milking robots that automatically perform the milking of the dairy animals.

18. The method of claim 16, wherein the milk is tested according to a criterion related to the voluntary production of milk and only the milk that satisfies the criterion is processed.

19. The method of claim 18, wherein the criterion is an animal welfare criterion.

20. The method of claim 18, wherein the criterion is a milk quality criterion.

21. The method of claim 16, wherein the milking facility is tested according to a criterion related to the voluntary production of milk and only milk from facilities that satisfy the criterion is processed.

22. The method of claim 21, wherein the criterion is an animal welfare criterion.

23. The method of claim 21, wherein the criterion is a public health criterion.

24. The method of claim 21, wherein the criterion is an environmental criterion.

25. The method of claim 16, further comprising marking the package with a criterion related to the voluntary production of milk.

26. The method of claim 25, further comprising marking the package with an indication identifying a particular milking facility from which the milk has been collected.

27. A package containing a processed milk product derived exclusively from the milk of dairy animals in a voluntary milking facility, in which the dairy animals are allowed voluntary access to visit milking machines for the purpose of milking, the package comprising an indication of a voluntary milking criterion related to the voluntary production of the milk.

28. The packaged milk product of claim 27, further comprising an indication identifying the milking facility.
